(19) United States
(12) Patent Application Publication
(10) Pub. No.: US 2023/0406442 A1
(43) Pub. Date: Dec. 21, 2023

(54) ELECTRONIC MOTORCYCLE THROTTLE WITH LINEAR TRANSMISSION

(71) Applicants: Dietmar MAEHR, Duens (AU); Michael PRIMOSCH, Feldkirch (AU); Thomas GROHS, Tschagguns (AU)

(72) Inventors: Dietmar MAEHR, Duens (AU); Michael PRIMOSCH, Feldkirch (AU); Thomas GROHS, Tschagguns (AU)

(21) Appl. No.: 18/035,741

(22) PCT Filed: Dec. 17, 2021
(86) PCT No.: PCT/EP2021/086523

§ 371 Date: May 6, 2023

(30) Foreign Application Priority Data
Dec. 17, 2020 (DE) 102020133942.9

(51) Int. Cl. B62K 23/04

(52) U.S. Cl. CPC B62K 23/04

(57) ABSTRACT

A device (1), in particular an electronic throttle system, in particular for motorcycles, having a handle (2) and a measuring arrangement assigned to this handle (3), wherein a rotary movement of the handle (2) is transmitted to and acts on the measuring arrangement, wherein means are provided which convert a rotary movement of the handle (2) into a limit movement of at least a part of the measuring arrangement.

The invention relates to a throttle, in particular an electronic throttle for a motorcycle, having a hand grip and a sensor coupled to this hand grip such that rotation of the hand grip is transmitted to the sensor and acts thereon according to the features of the preamble of patent claim 1.

An electronic throttle for motorcycles is known from EP 1 464 571 that is mounted on a link element and that has at least one rotary throttle element that is mounted on the link element so as to be rotatable in an actuating direction from an idle position to a full-throttle position, a rotary position encoder that is mounted outside the axis of rotation of the rotary throttle element, and the rotary position transmitter consists of a rotor and a stator. The rotor unit is rotatable with the rotary throttle unit relative to the stator, and the rotational axes of the rotor and the throttle element extend parallel and at a spacing from each other. The rotor unit is to be adjusted by an engagement element connected to the throttle element having a first number of teeth engaged with a second number of teeth on a tooth element that is coupled to the rotor or the rotor is at least partially configured as a toothed element. At least one return element is provided that acts on the rotor counter to the actuating direction such that the engagement between the first and second teeth is substantially free of play.

In this patent application, rotation is translated to a gear with magnet and the angle of rotation is measured by a magnet. This means that in this known throttle all the elements involved execute only rotation.

The object of the invention is to improve a throttle of the type in question, in particular with regard to its manufacture, its reliability and its compactness.

This object is attained by the features of claim 1.

It is known, as explained further above, that rotation of the hand grip is converted into rotation that influences the sensor.

The invention deviates from this principle. Rotation of the hand grip is converted into linear movement that influences the sensor.

According to the invention, means are provided for the purpose of converting rotation of the hand grip into linear movement of at least part of the sensor.

Those parts that are mounted on the hand grip, as well as those parts that are mounted on a base, can be produced in a very good and compact manner in front of all things. Wear during operation of the throttle is significantly reduced since only some parts of the hand grip are engaged with a smaller part of the sensor assembly on the base. Due to the fact that the parts of the sensor that are moved linearly on the base act on a sensor element, this linear movement can be detected substantially better by the sensor element and converted into an output signal than if rotation acted on the sensor element, as is the case in the prior art.

By changing the measuring technique in which rotation is converted into linear movement, it is possible to concentrate the entire sensor system in a semicylindrical housing. This is not possible with the prior-art rotating 3-pole segment magnet. The one half-shell can be installed with the entire sensor system in order to have the second half-shell free for various further operating elements. As a result, the entire operating system for the user is more compact and user friendly.

In a development of the invention, it is provided that the means have a straight rack of a base of the throttle and an arcuate pinion that interacts therewith and is operatively connected to the hand grip. The arrays of teeth that are straight or arcuate can be constructed in an optimum and compact manner and coordinated with one another. In addition, only part of the round toothed rack on the straight toothed rack is in engagement with these parts, so that wear is significantly reduced as a result. This advantageously affects the durability of the throttle. In addition, as a result, a compact construction of the entire throttle, in particular the elements mounted on the hand grip and the elements mounted on the base are achieved

In a development of the invention, provision is made for a magnet holder that can be moved for this purpose and has at least one magnet mounted on the base. This also makes it possible to achieve a particularly compact construction of those elements that are mounted on the base or that form the base itself. The base and the magnet holder can be two separate parts that are also produced separately from one another. Alternatively, it is conceivable that the base and the magnet holder form a single one-piece part. Preferably, these parts are produced in a plastic injection-molding process. This can be automated very well, even for high production numbers.

In a development of the invention, it is provided that the magnet holder carries the straight toothed rack. As a result, it is possible for the magnet holder to be formed on the one hand for receiving the at least one magnet that acts on a sensor element. On the other hand, the magnet holder simultaneously has the straight toothed rack that converts rotation of the hand grip into linear movement of the magnet holder, so that the at least one magnet is moved past the sensor element in a straight line. In a particularly advantageous manner, the magnet holder is produced in a plastic injection-molding process, and the at least one magnet is inserted into the injection mold and is overmolded with plastic. Thus, a one-piece element is available after its manufacture, that includes on the one hand the straight toothed rack and on the other hand also the at least one magnet that acts on the sensor element. This above all facilitates mounting of this element on the base of the throttle.

In a development of the invention, it is provided that the base has a sensor element that interacts with the at least one magnet. The at least one magnet thus forms the sensor in conjunction with the sensor element, and the at least one magnet is moved linearly past the sensor element. As a result, rotation of the hand grip can be detected very accurately and without error by the sensor element by conversion of rotation of the hand grip into linear movement of the at least one magnet.

In a development of the invention, it is provided that the base comprises a printed-circuit board supporting at least the sensor element. As a result, a compact construction of the base can be achieved. Either the printed circuit board forms the base or is integrated in the base. This integration can be achieved, for example, by overmolding the printed circuit board with the parts located thereon, in particular the sensor element. As a result, the parts including the sensor element and the printed circuit board themselves are protected from external influences and such a base can be mounted very easily.

In a development of the invention, it is provided that the hand grip forms a guide groove for guiding a part of the magnet holder. As a result, the interaction of the rotationally moved parts of the hand grip with the linearly moved part of the base is improved and precision of the sensor is increased. Alternatively, it is conceivable that the guide groove of the hand grip interacts only with a fixed element of the base (without a linearly moved part on the base, such as for example the magnet holder), so that guidance of the hand grip on the base is ensured thereby. In addition, it is also conceivable that the guide groove guides both the hand grip on the base and the linearly movable part of the base, in particular the magnet holder, in a defined manner during their movements as a result of rotation on the hand grip.

In a development of the invention, it is provided that the hand grip has a tube and the tube with the arcuate pinion rack and/or the magnet holder with the straight toothed rack consists of plastic material. The use of a tube for the hand grip has the advantage that it can be produced in a plastic injection-molding process, and the arcuate array of pinion teeth is preferably formed at the same time on an end of the tube. This tube can be provided with a casing that is, for example, ergonomically shaped or consists of a grippable material. This at least two-part embodiment of the hand grip has the advantage that it can be optimally adapted to its tasks (on the one hand grip and on the other hand to form the round toothed rack). The same applies to the magnet holder that can also be produced in a plastic injection-molding process during which the holder for the at least one magnet and the straight toothed rack can be formed. If a holder for the at least one magnet is formed, it can subsequently be inserted as a separate part in this holder and fixed, for example glued, pressed or latched. As an alternative to this, it can be envisaged to insert the at least one magnet into a mold already during manufacture of the magnet holder in the plastic injection molding process and then to encapsulate it. In this way, a subsequent assembly process of the at least one magnet is advantageously dispensed with.

In a development of the invention, it is provided that the same poles or the different poles of the two magnets face each other. As a result, the output characteristic of the sensor can specifically set or extend the linear path of the magnet holder from one end point to its other end point on the base. In a particularly advantageous manner, the sensor element, in particular a Hall element, is always acted upon by an almost homogeneous magnetic field when the magnet holder is linearly guided past the sensor element between its two end points. A two-part magnet system is thus installed since the resulting magnetic field can be better evaluated by a Hall sensor than in the case of a simple bar magnet. As a result, a greater signal strength can be realized over the measuring range, which results in a lower signal deviation and the system also makes more robust comparison with external interference fields.

In one embodiment, the hand grip (tube) has at its one end a circumferential gear formation. This arcuate toothed rack acts on a linearly displaceable block (rack) of the sensor (or part of the sensor), in which at least one magnet (specifically two magnets with magnetization directions aligned with respect to one another) is arranged. A corresponding sensor upon which the magnet acts is disposed on a printed circuit board (PCB) located below the slidable block. The rotation of the hand grip causes a linear displacement of the block, so that the at least one magnet is thereby moved linearly with respect to the sensor, so that this sensor can generate a corresponding signal

This means the translation from rotation into linear movement with an integrated magnet.

The sensor operates without contact, preferably on a magnetic basis, and the linear movement of the at least one magnet acts on a corresponding sensor element, in particular a Hall element, so that an output signal representing the position of the hand grip can be generated by the sensor element.

With regard to further details, reference is made to the drawing.

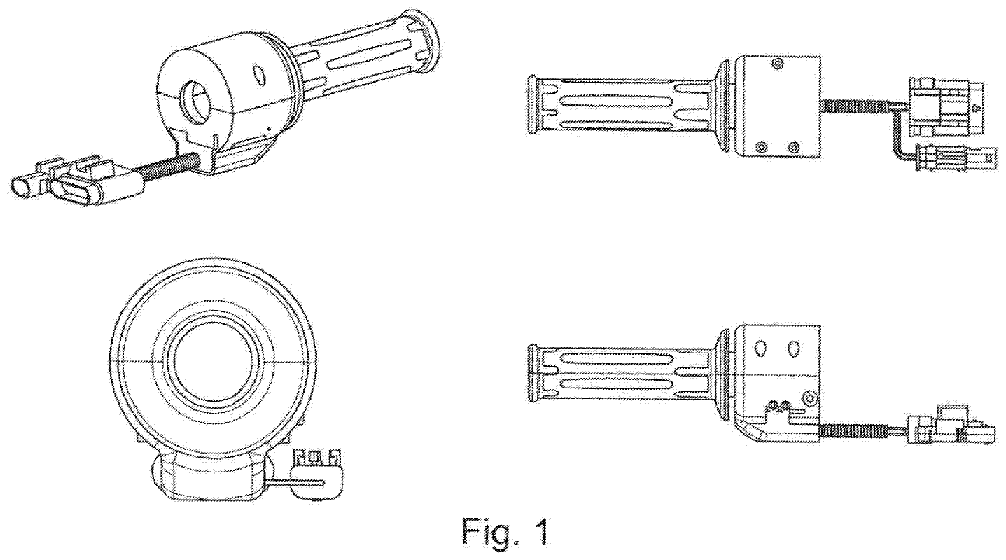

A throttle 1, in particular an electronic throttle, in particular for motorcycles, is shown in various views in FIG. 1, and this throttle 1 is explained in more detail below with reference to the further figures.

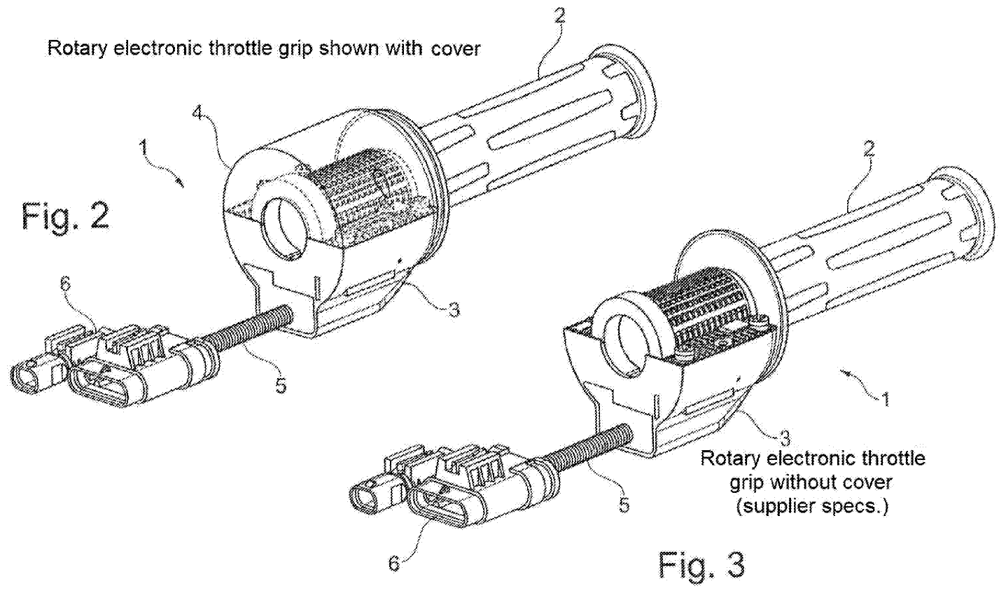

In FIGS. 2 and 3, the throttle 1 is shown in a three-dimensional view. The throttle 1 has a hand grip 2 rotatable about its longitudinal axis. Rotation of the hand grip 2 is preferably possible between two stops. Furthermore, a base 3 is shown that is fixed for example on a steering fork of a motorcycle. FIG. 2 shows that the base 3 has a cover 4 within which further elements of the throttle 1 to be described are mounted. In contrast, FIG. 3 shows the cover 4 removed. Furthermore, a cable 5 extends out of the base 3, and a plug-in connector 6 is mounted at one end of the cable 5, and the plug-in connector 6 is inserted into an electronic engine controller.

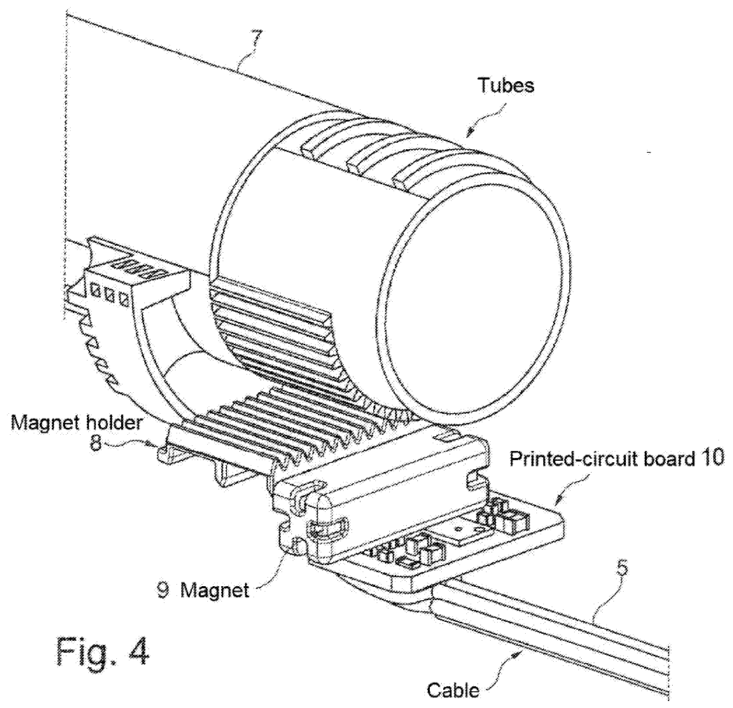

FIG. 4 shows further details of the throttle 1. The hand grip 2 comprises a tube 7 preferably extending over the entire length of the hand grip 2 and a distance beyond it as shown in FIG. 3. A magnet holder 8 with at least one magnet 9 is shown juxtaposed with the end of the tube 7. While the tube 7 is rotatable about its longitudinal axis by the action of the hand grip 2, the magnet holder 8 moves in a straight line tangentially relative to the base 3. The magnet holder 8 is juxtaposed with a printed circuit board 10 with electronic elements mounted thereon and at least one sensor element that is not described in more detail here. The magnet 9 acts on the sensor element, so that the output signal of the sensor element can be processed by the electronic parts on the printed circuit board 10 and can be fed to the electronic engine controller by the cable 5.

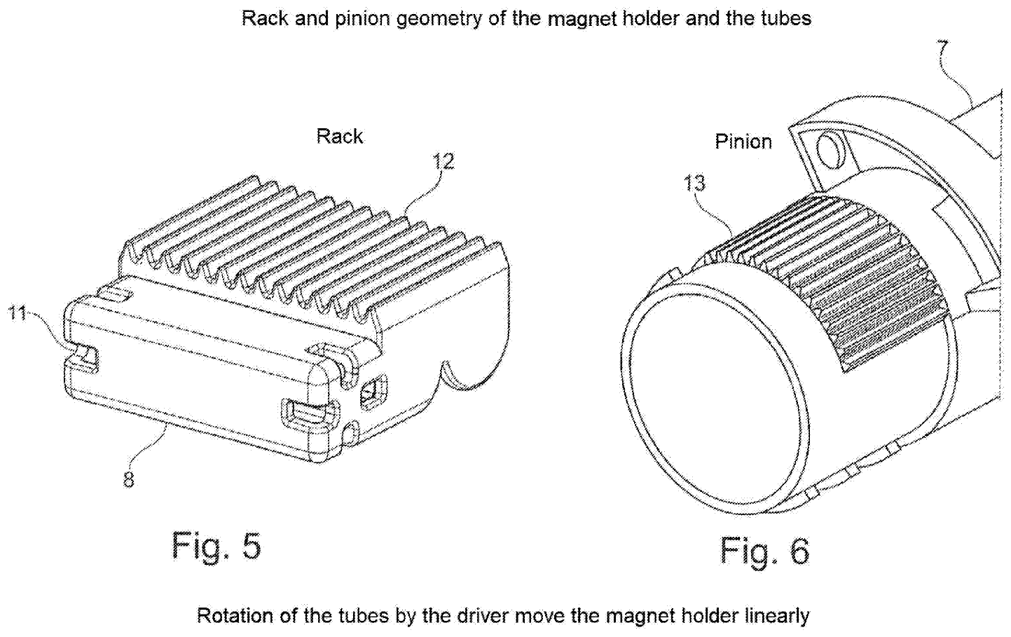

Further individual parts of the throttle 1 are shown in FIGS. 5 and 6.

FIG. 5 shows the magnet holder 8 that has a seat 11 for the magnet 9 that is not yet inserted here. This magnet 9 is inserted into the seat 11 and permanently fixed, for example by pressing, latching, adhesive bonding or the like. As an alternative to this, it is conceivable that the magnet holder 8 is produced in a plastic injection molding process and the magnet 9 is integrated in the magnet holder 8 permanently in a fixed position. In addition, the magnet holder 8 has a straight toothed rack 12. In this embodiment, the seat 11 is designed in the form of a pocket in such a way that the magnet 9 is exposed on the front side and in a small part after insertion into the seat 11. This has the advantage that visual inspection of the finished magnet holder 8 can take place and it can be checked whether the magnet 9 (at least one) has been inserted into the magnet holder 8.

FIG. 6 shows an end of the tube 7 that extends into the cover 4 of the base 3. It can easily be seen that this one end of the tube 7 carries over a full circumferential or, as in this embodiment, part-cylindrical array of teeth forming a pinion 13. The shape of the teeth of both the straight toothed rack 12 of the magnet holder 8 and of the arcuate array of pinion teeth 13 on the end of the tube 7 are complementary such that rotation of the tube 7 is converted to linear displacement of the magnet holder 8 relative to the base 3. This linear movement is detected by the effect of the magnetic field of the at least one magnet 9 on the sensor element on the printed circuit board 10 and converted into a corresponding output signal.

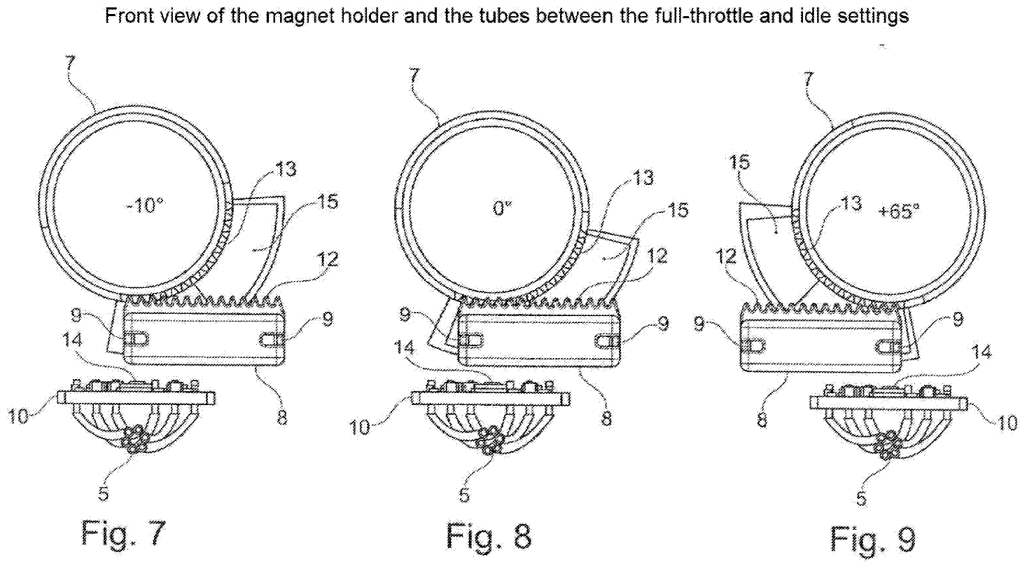

FIGS. 7 to 9 show, in cross section through the tube 7, different positions of the magnet holder 8 with respect to the base 3, illustrated by way of example on the basis relative to the printed circuit board 10.

While the one angular end position of the hand grip 2 (represented by the tube 7) is shown in FIG. 7, a neutral position of the hand grip 2 is shown in FIG. 8 and the other end position of the hand grip 2 is shown in FIG. 9. While the neutral position of the hand grip 2 is indicated at 0° in FIG. 8, the one end position in FIG. 7 is reached during a rotation by −10° and the other end position in FIG. 9 is reached during a rotation by +65°. These rotational ranges in degrees are purely exemplary and can vary depending on the application. Thus, it is conceivable, for example, that, starting from the neutral position in both directions, a rotation about the same number of degrees, thus the same angle section, is possible. Also, degree numbers for the end positions (that is to say the angular ranges that are traversed during rotation of the hand grip) can be greater or smaller than those indicated by way of example by numbers. Rotation of the hand grip 2 by up to ±180° or possibly also only in one direction (starting from a neutral position) is also conceivable in principle. It is also not absolutely necessary to have a perceptible neutral position between the two end positions.

FIG. 7 shows that a sensor element 14, in particular a Hall element, is carried on the printed circuit board 10 in addition to other electronic parts. The cable 5 consists of a plurality of individual electrical conductors, and each electrical conductor is connected appropriately to the circuit board 10.

It can also be seen in FIGS. 7 to 9 that the tube 7 has an angularly extending arcuate guide groove 15 (shown over a part of its circumference). This guide groove 15 cooperates with an unillustrated guide element on the base 3 in order to delimit a defined rotational movement of the tube 7 about its longitudinal axis. The hand grip 2 is rotated by an external force outside (for example by the driver of the motorcycle), the guide groove 15 can alternatively or additionally also interact with a guide element (not shown) of the magnet holder 8 so that the tube 7 together with the magnet holder 8 execute a defined common angular movement (rotational movement of the tube 7 and linear movement of the magnet holder 8).

In the embodiment shown in FIGS. 7 to 9, magnets 9 mounted at a spacing from the magnet holder 8 are mounted in (or from the outside). Of course, only a single magnet 9 or more than two magnets 9 can also be provided in or from the outside of the magnet holder 8. In addition, the arcuate array of pinion teeth 13 here extends angularly only over part of the circumference of the tube 7, approximately 45°. This extension can be extended according to application and be greater than or less than 45°. The length of the straight toothed rack 12 can also be adapted accordingly.

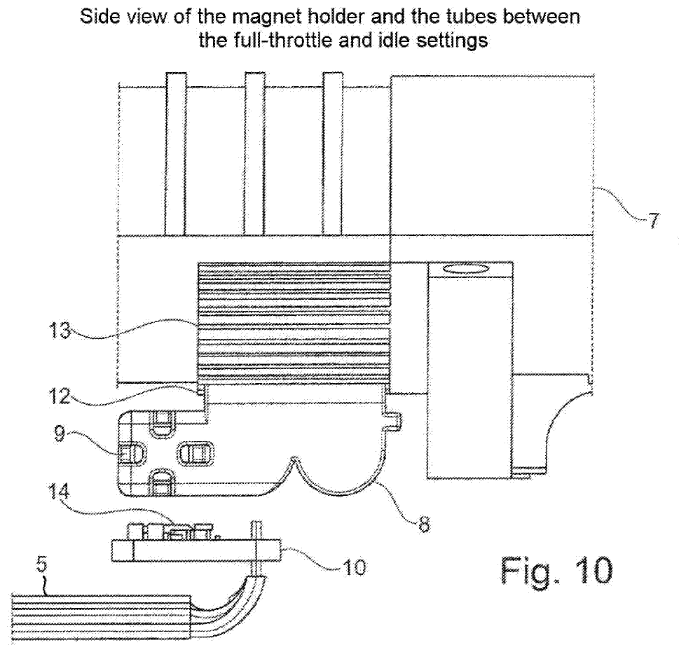

FIG. 10 shows the embodiment of FIGS. 7 to 9 in different positions in side view. In this case, it can be seen very clearly that the guide groove 15 of the tube 7 does not interact with the magnet holder 8. The element on the base 3 with which it interacts is not shown. The juxtaposition of the at least one magnet 9 with respect to the sensor element 14 can be clearly seen with an air gap present between them, so that the at least one magnet 9 can sweep over the sensor element 14 with its magnetic field during the linear movement of its magnet holder 8 via the printed circuit board 10.

In addition, it can be seen in FIG. 10 that (in this position shown of the tube 7 or hand grip 2) in the upper half of the tube 7, for example, three ridges extend angularly around the outer surface of the tube 7. More than three or less than three ridges may also be present. If fewer than three ridges are present, they may (but need not) be designed to be correspondingly wider, whereas in the presence of more than three ridges they can be designed to be correspondingly narrower (but need not). These ridges reinforce the region of the tube 7 adjacent the arcuate array of pinion teeth portion 13, so that at the end of the tube 7 where the ridges and the lower rack 13 are provided (and optionally also in addition), the tube 7 is sufficiently stable and there is also a uniform distribution of forces during rotation of the hand grip 2.

Preferably, the tooth width of the straight toothed rack 12 corresponds to the tooth width of the arcuate array of pinion teeth 13. Different widths are also conceivable depending on the installation space.

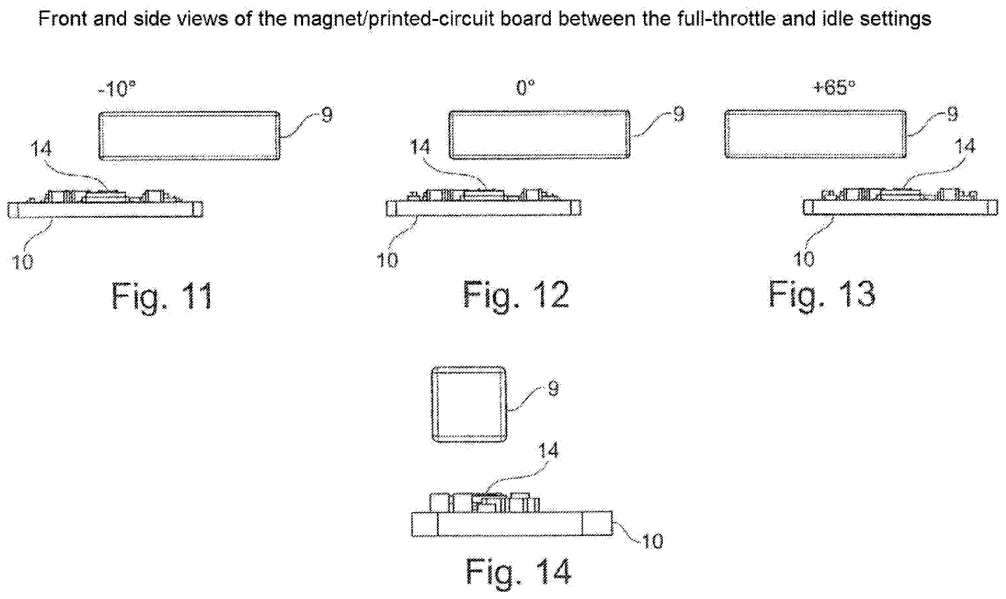

Analogously to the various positions shown in FIGS. 7 to 9, the relative positions of the at least one (single) magnet 9 and the sensor element 14 are shown once again in FIGS. 11 to 13. The same applies to FIG. 14 that shows a side view corresponding to FIG. 10 once again; here too, only the at least one (single) magnet 9 is shown in its position relative to the sensor element 14.

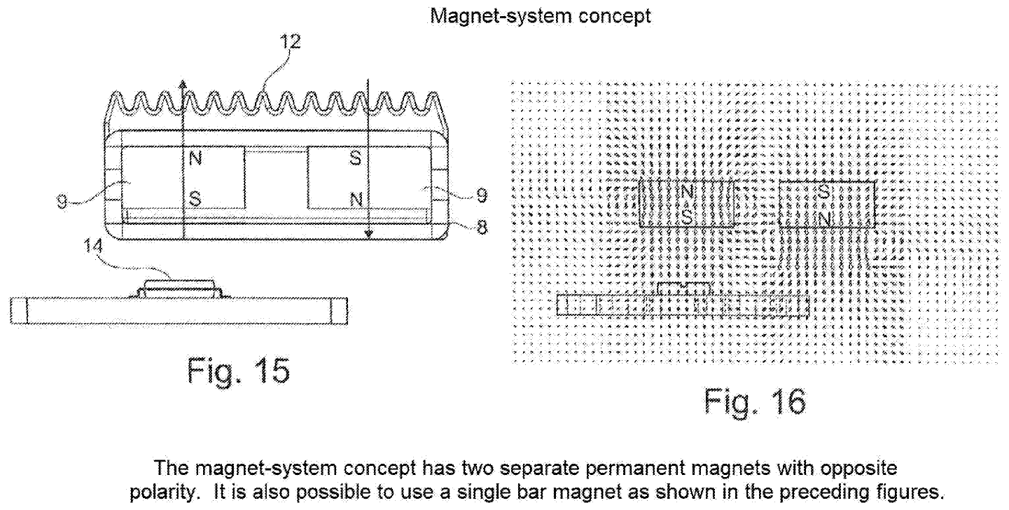

FIGS. 15 and 16 show an embodiment with two magnets 9 that are mounted in (or alternatively from the outside) to the magnet holder 8. Preferably, the magnet holder 8 is made of plastic and is produced in a plastic injection-molding process, and in this method the two magnets 8 are mounted within the magnet holder 8 and are thus protected, and the straight toothed rod section 12 has also been produced with this method.

FIG. 15 again shows the printed circuit board 10 with the sensor element 14 mounted thereon, and an air gap is provided between the sensor element 14 and the magnet holder 8, and the magnet holder 8 can sweep over the sensor element 14 from right to left and vice versa as a result of rotation of the hand grip 2. In this case, the magnetic field of the two magnets 9 is applied to the sensor element 14, so that a corresponding output signal is generated as a function of the position of the hand grip 2, which output signal is supplied to the electronic throttle for evaluation or generation of a corresponding output.

In FIG. 16, based on the structure shown in FIG. 15, the magnetic field of the two magnets 9 is shown that acts on the sensor element 14. In this case, it can be seen very clearly that an almost homogeneous magnetic field is generated by the presence of the two magnets 9 in the region of the magnetic field that acts upon the sensor element 14 when it is swept over, and can thus be evaluated. This has the advantage that no error correction of the output signal of the sensor element 14 has to take place in the downstream electronic throttle. As a result, a very sensitive control, for example of the drive of the motorcycle, is possible by rotation of the hand grip 2.

FIGS. 15 and 16 show that the different poles of the two magnets face each other. The left magnet 9 has a north pole N and a south pole S, with the north pole N still pointing upward as shown in FIGS. 15 and 16. In contrast, the right-hand magnet 9 has an upward-pointing south pole S and a downward-pointing north pole N (as viewed in FIGS. 15 and 16). Thus, the different poles of the two magnets 9 face each other. As a result, the output characteristic curve of the sensor can be adjusted in a targeted manner or the linear path of the magnet holder can be extended from its one end point to its other end point on the base. In a particularly advantageous manner, the sensor element, in particular a Hall element, is always acted upon by an almost homogeneous magnetic field when the magnet holder moves in a straight line past the sensor element between its two end positions. A two-part magnet system is thus installed since the resulting magnetic field can be better evaluated by a Hall sensor than in the case of a simple bar magnet. As a result, greater signal strength can be realized over the measuring range, which results in a lower signal deviation and the system also makes more robust comparison with external interference fields.

### LIST OF REFERENCE SIGNS

| | |
|---|---|
| 1 | throttle |
| 2 | hand grip |
| 3 | base |
| 4 | cover |
| 5 | cable |
| 6 | plug-in connector |
| 7 | tube |
| 8 | magnet holder |
| 9 | magnet |
| 10 | printed circuit board |
| 11 | pick-up |
| 12 | rack (straight) |
| 13 | rack (round) |
| 14 | sensor element |
| 15 | guide groove |

1. A throttle for a motorcycle, the throttle comprising:
a hand grip;
sensor operatively connected to this hand grip such that rotation of the hand grip is transmitted to the sensor and acts thereon; and
means for converting rotation of the hand grip into linear movement of at least part of the sensor.

2. The throttle according to claim 1, wherein the means comprise:
a base;
a straight toothed rack on the base of the throttle and
an arcuate array of pinion teeth cooperating therewith and coupled to the hand grip.

3. The throttle according to claim 2, the means further comprising:
a movable magnet holder; and
a magnet mounted on the base.

4. The throttle according to claim 3, wherein the magnet holder is connected to the straight toothed rack.

5. The throttle according to claim 3, wherein the means has;
a sensor element that interacts with the a magnet.

6. The throttle according to claim 5, wherein the means comprises:
a printed circuit board on which at least the sensor element is mounted.

7. The throttle according to claim 3, wherein the hand grip is formed with a guide groove for guiding part of the magnet holder.

8. The throttle according to claim 3, wherein the hand grip has:
a tube carrying the arcuate array of pinion teeth and/or the magnet holder and the straight toothed rack consists of plastic.

9. The throttle according to claim 1, wherein the sensor comprises exactly two magnets spaced from one another.

10. The throttle according to claim 9, wherein the same poles or opposite poles of the two magnets face one another.

11. A throttle comprising:
a hand grip rotatable about an axis;
an arcuate array of pinion teeth carried on the grip and centered on the axis;
a straight rack meshing with the array of pinion teeth and movable tangentially of the grip;
a magnet holder carried on and movable with the rack;
a magnet carried by the holder; and
a fixed electronic sensor juxtaposed with the magnet for generating an output corresponding to a tangential position of the holder and magnet.
